(19) United States
(12) Patent Application Publication
(10) Pub. No.: US 2026/0241715 A1
(43) Pub. Date: Aug. 20, 2026

(54) Trajectory Generation Method, Three-Dimensional Object Printing System, And Three-Dimensional Object Printing Apparatus

(71) Applicant: SEIKO EPSON CORPORATION, Tokyo (JP)

(72) Inventor: Kohei UTSUNOMIYA, Matsumoto (JP)

(21) Appl. No.: 19/542,989

(22) Filed: Feb. 18, 2026

(30) Foreign Application Priority Data
Feb. 19, 2025 (JP) 2025-025213

(51) Int. Cl. B41J 11/00; B41J 3/407

(52) U.S. Cl. CPC B41J 11/008; B41J 3/4073; B41J 2203/011

(57) ABSTRACT

A trajectory generation method for scanning a liquid ejection head in a three-dimensional object printing apparatus including the liquid ejection head and a moving mechanism for changing a relative position of the liquid ejection head with respect to a workpiece, the method includes a shape acquisition step of acquiring shape information on a shape of the workpiece, a division information acquisition step of acquiring division information indicating at least one direction, a division step of dividing a target region on the workpiece in accordance with the division information to generate a plurality of division regions, and a trajectory generation step of generating, for each division region of the plurality of division regions, a printing trajectory of the liquid ejection head.

The present application is based on, and claims priority from JP Application Serial Number 2025-025213, filed Feb. 19, 2025, the disclosure of which is hereby incorporated by reference herein in its entirety.

### BACKGROUND

### 1. Technical Field

The present disclosure relates to a trajectory generation method, a three-dimensional object printing system, and a three-dimensional object printing apparatus.

### 2. Related Art

A three-dimensional object printing apparatus that performs printing on a surface of a three-dimensional workpiece by an ink jet method is known. For example, JP-A-2010-284965 discloses a printing apparatus provided with an ink jet head, a slide rail, and a rotating unit. In this printing apparatus, the ink jet head moves along an axial direction of the slide rail and prints a character or a design on a component to be printed mounted on the rotating unit. At this time, the print design is divided into a plurality of print regions based on different surfaces to be printed of the component to be printed, and then each print region is separately and sequentially printed on a different surface to be printed.

In JP-A-2010-284965, there is no specific description of how the print region is divided. Under such circumstances, in recent years, it has been desired that a user can perform printing on any workpiece and within any printing range in high-mix low-volume production, and further improvements have been required.

### SUMMARY

According to an aspect of the present disclosure, there is provided a trajectory generation method for scanning a liquid ejection head in a three-dimensional object printing apparatus including the liquid ejection head configured to eject a liquid toward a three-dimensional workpiece, and a moving mechanism configured to hold the liquid ejection head and change a relative position of the liquid ejection head with respect to the workpiece, the trajectory generation method including a shape acquisition step of acquiring shape information on a shape of the workpiece, a division information acquisition step of acquiring division information indicating at least one direction, a division step of dividing a target region on the workpiece in accordance with the division information to generate a plurality of division regions, and a trajectory generation step of generating, for each division region of the plurality of division regions, a printing trajectory of the liquid ejection head.

According to another aspect of the present disclosure, there is provided a three-dimensional object printing system including a liquid ejection head configured to eject a liquid toward a three-dimensional workpiece, a moving mechanism configured to hold the liquid ejection head and change a relative position of the liquid ejection head with respect to the workpiece, and a trajectory generation unit configured to generate a printing trajectory for scanning the liquid ejection head, in which the trajectory generation unit is configured to acquire shape information on a shape of the workpiece, acquire division information indicating at least one direction, generate a plurality of division regions by dividing a target region on the workpiece in accordance with the division information, and generate a printing trajectory of the liquid ejection head for each division region of the plurality of division regions.

According to still another aspect of the present disclosure, there is provided a three-dimensional object printing apparatus including a liquid ejection head configured to eject a liquid toward a three-dimensional workpiece, a moving mechanism configured to hold the liquid ejection head and change a relative position of the liquid ejection head with respect to the workpiece, and a trajectory generation unit configured to generate a printing trajectory for scanning the liquid ejection head, in which the trajectory generation unit is configured to acquire shape information on a shape of the workpiece, acquire division information indicating at least one direction, generate a plurality of division regions by dividing a target region on the workpiece in accordance with the division information, and generate a printing trajectory of the liquid ejection head for each division region of the plurality of division regions.

### BRIEF DESCRIPTION OF THE DRAWINGS

FIG. 1 is a schematic view of a three-dimensional object printing apparatus used in a printing method according to an embodiment.

FIG. 2 is a block diagram showing an electrical configuration of the three-dimensional object printing apparatus used in a printing method according to the embodiment.

FIG. 3 is a perspective view of a robot.

FIG. 4 is a block diagram of a computer used for generating path data.

FIG. 5 is an explanatory diagram of printing with respect to the workpiece.

FIG. 6 is a flowchart showing a trajectory generation method according to the embodiment.

FIG. 7 is a diagram of a display example used to acquire division information.

FIG. 8 is an explanatory diagram of a plurality of division regions.

FIG. 9 is a diagram showing an example of a plurality of trajectory candidates.

FIG. 10 is a diagram showing an example of the plurality of trajectory candidates.

FIG. 11 is an explanatory diagram of the plurality of trajectory candidates.

FIG. 12 is an explanatory diagram of correction of the plurality of trajectory candidates.

FIG. 13 is an explanatory diagram of a plurality of printing trajectories.

FIG. 14 is an explanatory diagram of another example of the plurality of printing trajectories.

FIG. 15 is an explanatory diagram of another example of the plurality of printing trajectories.

FIG. 16 is an explanatory diagram of another example of the plurality of printing trajectories.

FIG. 17 is an explanatory diagram of another example of a plurality of division regions.

FIG. 18 is a diagram showing an example of a workpiece having a recessed portion.

FIG. 19 is an explanatory diagram of a case where a plurality of division regions are generated without smoothing a shape of the workpiece shown in FIG. 18.

FIG. 20 is an explanatory diagram of a state after the shape of the workpiece shown in FIG. 18 is smoothed.

FIG. 21 is an explanatory diagram of a case where a plurality of division regions are generated after the shape of the workpiece shown in FIG. 18 is smoothed.

FIG. 22 is an explanatory diagram of a plurality of division regions in a case where the workpiece has two separated portions.

FIG. 23 is a view of the plurality of division regions shown in FIG. 22 as viewed from another direction.

### DESCRIPTION OF EMBODIMENTS

Hereinafter, preferred embodiments according to the present disclosure will be described with reference to the accompanying drawings. In the drawings, the dimensions and scales of each portion are different from actual ones as appropriate, and some parts are schematically illustrated for ease of understanding. Further, the scope of the present disclosure is not limited to these forms unless it is stated in the following description that the present disclosure is particularly limited.

In the following description, for convenience, an X-axis, a Y-axis, and a Z-axis that intersect with each other will be appropriately used. In addition, hereinafter, one direction along the X-axis is an X1 direction, and a direction opposite to the X1 direction is an X2 direction. Similarly, directions opposite to each other along the Y- axis are a Y1 direction and a Y2 direction. Further, directions opposite to each other along the Z- axis are a Z1 direction and a Z2 direction.

Here, the X-axis, the Y-axis, and the Z-axis are coordinate axes of a world coordinate system set in the space in which a robot 2 and a holding robot 4 to be described later are installed. Typically, the Z-axis is a vertical axis, and the Z2 direction corresponds to a downward direction in a vertical direction. A base coordinate system based on base portions 210 and 410 to be described later is associated with the world coordinate system by calibration. Hereinafter, for convenience, a case where operations of the robot 2 and the holding robot 4 are controlled by using the world coordinate system as a robot coordinate system will be exemplified.

The Z-axis may not be a vertical axis. Although the X-axis, the Y-axis, and the Z-axis are typically orthogonal to each other, the present disclosure is not limited thereto, and the axes may not be orthogonal to each other. For example, the X-axis, Y-axis, and Z-axis may intersect with each other at an angle within a range of 80° or more and 100° or less.

### 1. First Embodiment

### 1-1. Outline of Three-Dimensional Object Printing Apparatus

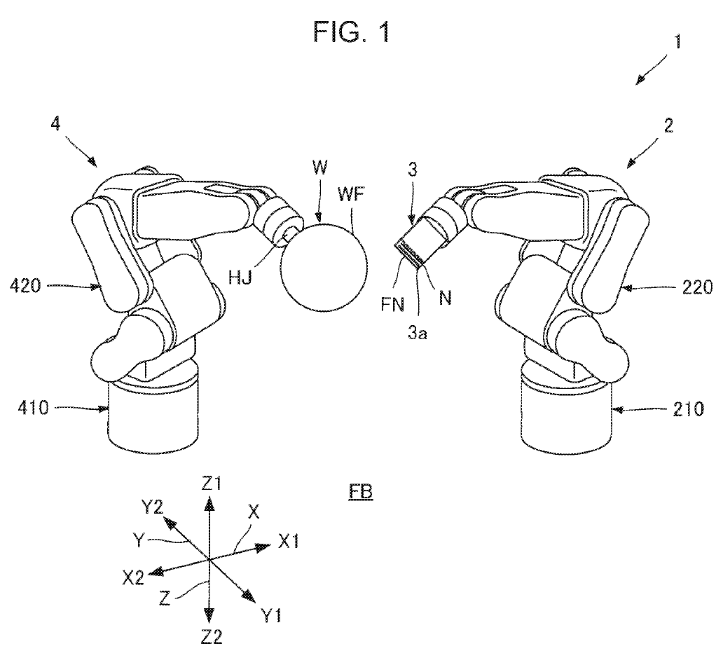

FIG. 1 is a schematic view of a three-dimensional object printing apparatus 1 used in a printing method according to an embodiment. The three-dimensional object printing apparatus 1 is an apparatus that performs printing on a surface of a workpiece W by an ink jet method. The three-dimensional object printing apparatus 1 is an example of a "three-dimensional object printing system".

The workpiece W is an object on which an image based on print data Img to be described later is printed. In the example shown in FIG. 1, the workpiece W is a substantially hemispherical body and has a target region WF that is a spherical surface. In the present embodiment, the target region WF is the entire surface of the workpiece W. A size, a shape, or an installation orientation of the workpiece W is not limited to the example shown in FIG. 1, and is appropriately selected. The target region WF may be a part of the surface of the workpiece W.

As shown in FIG. 1, the three-dimensional object printing apparatus 1 includes the robot 2, a head unit 3, and the holding robot 4. The robot 2 is an example of a "moving mechanism". Hereinafter, first, each portion of the three-dimensional object printing apparatus 1 will be sequentially and briefly described with reference to FIG. 1.

The robot 2 is a robot that supports the head unit 3 and changes a position and an orientation of the head unit 3 in the world coordinate system. In the example shown in FIG. 1, the robot 2 is a so-called six-axis vertical articulated robot.

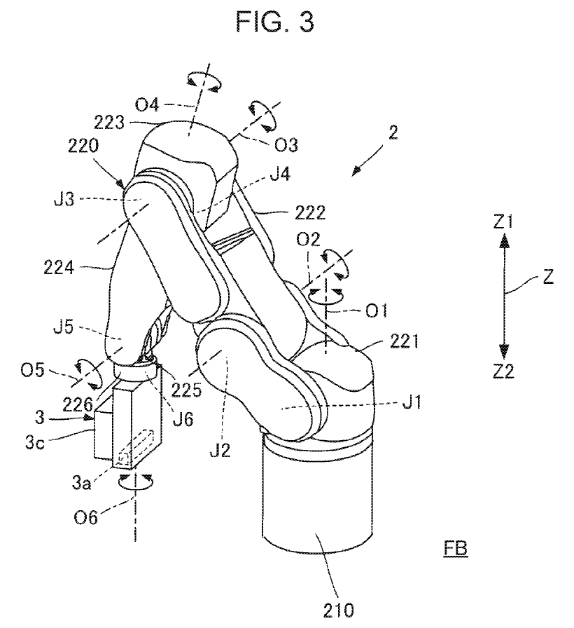

The robot 2 includes a base portion 210 and an arm 220. The base portion 210 is a base that supports the arm 220 and is fixed to an installation surface FB by screwing or the like. The arm 220 is a robot arm, and the head unit 3 as an end effector is mounted to a tip end of the arm 220 in a state of being fixed by screwing or the like. In this way, the robot 2 holds a liquid ejection head 3a and changes the relative position and orientation of the liquid ejection head 3a with respect to the workpiece W. Details of the robot 2 will be described later with reference to FIG. 3.

The installation surface FB is a surface facing the Z1 direction, and is, for example, an outer surface of an installation base or a floor surface of a building.

The head unit 3 is an assembly having the liquid ejection head 3a that ejects an ink, which is an example of a "liquid", toward the workpiece W. The liquid ejection head 3a has a nozzle surface FN, and a plurality of nozzles N for ejecting the ink are opened in the nozzle surface FN. The plurality of nozzles N constitute one or more nozzle rows arranged in a straight line. In the present embodiment, the head unit 3 includes a curing light source 3c in addition to the liquid ejection head 3a. The head unit 3 will be described later in detail with reference to FIG. 3.

The ink is not particularly limited, and examples thereof include an aqueous ink in which a coloring material such as a dye or a pigment is dissolved in an aqueous solvent, a curable ink using a curable resin such as an ultraviolet curable type resin, a solvent-based ink in which a coloring material such as a dye or a pigment is dissolved in an organic solvent, and the like.

On the other hand, the holding robot 4 is a robot that holds the workpiece W and changes the position and the orientation of the workpiece W in the world coordinate system. In the example shown in FIG. 1, the holding robot 4 is a six-axis vertical articulated robot.

The holding robot 4 includes a base portion 410 and an arm 420. The base portion 410 is a base that supports the arm 420 and is fixed to the installation surface FB by screwing or the like. The arm 420 is a robot arm, and a workpiece holding portion HJ as an end effector is mounted on a tip end of the arm 420 in a state of being fixed by screwing or the like.

The holding robot 4 is configured in the same manner as the robot 2 except that the end effector to be mounted is different. However, the robot 2 and the holding robot 4 may have different configurations from each other, and in the present embodiment, the configurations such as the arm length or the weight capacity are different from each other as necessary. Further, the number of joints of the robot 2 and the holding robot 4 may be different from each other. The base portion 410 may be fixed to a surface different from the installation surface FB, or may be fixed to a surface different from that of the base portion 210 of the robot 2.

The workpiece holding portion HJ is a robot hand that detachably holds the workpiece W. Here, "holding" is a concept including both sucking and gripping. For example, as the workpiece holding portion HJ, a suction mechanism for the workpiece W by negative pressure, an attraction mechanism by magnetic force, a gripping hand mechanism having a plurality of fingers, claws, or the like, and the like are exemplified.

Each of the robot 2, the head unit 3, and the holding robot 4 described above operates under the control of a control unit 10 to be described later. For example, under the control of the control unit 10 to be described later, in a state in which the holding robot 4 disposes the workpiece W at a desired position, the robot 2 moves the head unit 3 along the target region WF of the workpiece W while the head unit 3 ejects the ink toward the target region WF of the workpiece W. Accordingly, the three-dimensional object printing apparatus 1 performs a printing operation in which the robot 2 moves the liquid ejection head 3a along a target region RP, which will be described later, of the workpiece W while ejecting the ink from the liquid ejection head 3a.

Here, the holding robot 4 changes one or both of the position and the orientation of the workpiece W before the printing operation. As a result, manual orientation change or position adjustment of the workpiece W can be omitted.

The holding robot 4 may be omitted as necessary. In this case, the workpiece W is installed at a desired position in a desired orientation by a jig that holds the workpiece W. In addition, the workpiece W may be installed manually.

### 1-2. Electrical Configuration of Three-Dimensional Object Printing Apparatus

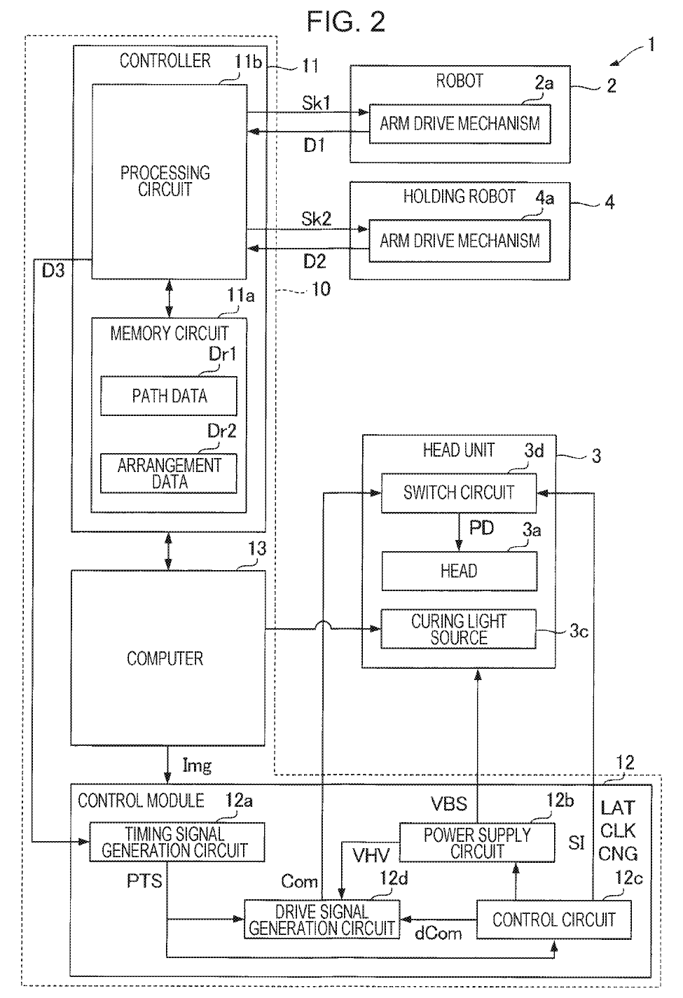

FIG. 2 is a block diagram showing an electrical configuration of the three-dimensional object printing apparatus 1 used in a printing method according to the embodiment. In FIG. 2, among components of the three-dimensional object printing apparatus 1, electrical components are shown. As shown in FIG. 2, the three-dimensional object printing apparatus 1 includes the control unit 10 in addition to the robot 2, the head unit 3, and the holding robot 4 described above. The control unit 10 is an example of a "trajectory generation unit".

The control unit 10 controls operations of the robot 2, the head unit 3, and the holding robot 4. In the example shown in FIG. 2, the control unit 10 includes a controller 11, a control module 12, and a computer 13.

Each electrical component shown in FIG. 2 may be appropriately divided, a part thereof may be included in another component, or may be integrally formed with the other component. For example, a part or all of the functions of the controller 11 or the control module 12 may be realized by the computer 13, or may be realized by another external apparatus such as a personal computer (PC) connected to the controller 11 via a network such as a local area network (LAN) or the Internet.

The controller 11 is a robot controller that controls driving of the robot 2 and the holding robot 4. The controller 11 has a function of controlling driving of the robot 2 and the holding robot 4, and a function of generating a signal D3 for synchronizing an ink ejection operation in the head unit 3 with an operation of the robot 2. The controller 11 includes a memory circuit 11a and a processing circuit 11b.

The memory circuit 11a stores various programs to be executed by the processing circuit 11b and various types of data to be processed by the processing circuit 11b. The memory circuit 11a includes, for example, one or both semiconductor memories of a volatile memory such as a random access memory (RAM) and a non-volatile memory such as a read only memory (ROM), an electrically erasable programmable read-only memory (EEPROM) or a programmable ROM (PROM). A part or all of the memory circuit 11a may be included in the processing circuit 11b.

The memory circuit 11a stores path data Dr1 and arrangement data Dr2.

The path data Dr1 is information related to a printing trajectory RU, which will be described later, of the head unit 3 by the robot 2, and includes information indicating the position and orientation of the liquid ejection head 3a in the printing operation. The arrangement data Dr2 is information related to the position and orientation of the workpiece W by the holding robot 4, and includes information indicating the position and orientation of the workpiece W in the printing operation. The arrangement data Dr2 may include information indicating the position and orientation of the workpiece W before and after the printing operation. Each of the path data Dr1 and the arrangement data Dr2 is generated by the computer 13.

The processing circuit 11b controls an operation of an arm drive mechanism 2a of the robot 2 based on the path data Dr1, and generates the signal D3. Further, the processing circuit 11b controls an operation of an arm drive mechanism 4a of the holding robot 4 based on the arrangement data Dr2. The processing circuit 11b includes, for example, one or more processors such as a central processing unit (CPU). The processing circuit 11b may include a programmable logic device such as a field-programmable gate array (FPGA) instead of the CPU or in addition to the CPU.

The arm drive mechanism 2a includes a motor for driving each joint of the robot 2 and an encoder for detecting a rotation angle of each joint of the robot 2. Similarly, the arm drive mechanism 4a includes a motor for driving each joint of the holding robot 4 and an encoder for detecting a rotation angle of each joint of the holding robot 4.

The processing circuit 11b performs inverse kinematics calculation which is a calculation that converts the position and the orientation indicated by the path data Dr1 into operation amounts such as rotation angles and rotation speeds of respective joints of the robot 2. Then, the processing circuit 11b outputs a control signal Sk1 based on output D1 from the respective encoders of the arm drive mechanism 2a so that the actual operation amounts such as the rotation angles and rotation speeds of the respective joints become the above-described calculation result. The control signal Sk1 controls the driving of the motor of the arm drive mechanism 2a.

Similarly, the processing circuit 11b performs inverse kinematics calculation which is a calculation that converts the position and the orientation indicated by the arrangement data Dr2 into operation amounts such as rotation angles and rotation speeds of respective joints of the holding robot 4. Then, the processing circuit 11b outputs a control signal Sk2 based on output D2 from the respective encoders of the arm drive mechanism 4a so that the actual operation amounts such as the rotation angles and rotation speeds of the respective joints become the above-described calculation result. The control signal Sk2 controls the driving of the motor of the arm drive mechanism 4a.

In addition, the processing circuit 11b generates the signal D3 based on the output D1 from at least one of the plurality of encoders of the arm drive mechanism 2a. For example, the processing circuit 11b generates, as the signal D3, a trigger signal including a pulse at a timing at which the output D1 from one of the plurality of encoders becomes a predetermined value.

The control module 12 is a circuit module that is communicably connected to the controller 11 and that controls the head unit 3. The control module 12 is a circuit that controls the ink ejection operation in the head unit 3 based on the signal D3 output from the controller 11 and print data Img, which will be described later, from the computer 13. The control module 12 includes a timing signal generation circuit 12a, a power supply circuit 12b, a control circuit 12c, and a drive signal generation circuit 12d.

The timing signal generation circuit 12a generates a timing signal PTS, based on the signal D3. The timing signal generation circuit 12a is configured with, for example, a timer that starts generation of the timing signal PTS by using detection of the signal D3 as a trigger.

The power supply circuit 12b receives power supply from a commercial power supply (not shown) to generate various predetermined potentials. The various generated potentials are appropriately supplied to each portion of the control module 12 and the head unit 3. For example, the power supply circuit 12b generates a power supply potential VHV and an offset potential VBS. The offset potential VBS is supplied to the head unit 3. In addition, the power supply potential VHV is supplied to the drive signal generation circuit 12d.

The control circuit 12c generates a control signal SI, a waveform designation signal dCom, a latch signal LAT, a clock signal CLK, and a change signal CNG, based on the timing signal PTS. These signals are synchronized with the timing signal PTS. Among these signals, the waveform designation signal dCom is input to the drive signal generation circuit 12d, and the other signals are input to a switch circuit 3d of the head unit 3.

The control signal SI is a digital signal for designating an operation state of a drive element included in the liquid ejection head 3a of the head unit 3. Specifically, the control signal SI designates whether to supply a drive signal Com, which will be described later, to the drive element. With this designation, for example, whether to eject the ink from a nozzle corresponding to the drive element is designated, and the amount of ink ejected from the nozzle is designated. The waveform designation signal dCom is a digital signal for defining a waveform of the drive signal Com. The latch signal LAT and the change signal CNG are used together with the control signal SI and by defining a driving timing of the drive element, define an ejection timing of ink from the nozzle. The clock signal CLK is a reference clock signal synchronized with the timing signal PTS.

The control circuit 12c described above includes, for example, one or more processors such as a central processing unit (CPU). The control circuit 12c may include a programmable logic device such as a field-programmable gate array (FPGA) instead of the CPU or in addition to the CPU.

The drive signal generation circuit 12d is a circuit that generates the drive signal Com for driving each drive element included in the liquid ejection head 3a of the head unit 3. Specifically, the drive signal generation circuit 12d includes, for example, a DA conversion circuit and an amplifier circuit. In the drive signal generation circuit 12d, the DA conversion circuit converts the waveform designation signal dCom from the control circuit 12c from a digital signal to an analog signal, and the amplifier circuit uses the power supply potential VHV from the power supply circuit 12b to amplify the analog signal and generate the drive signal Com. The drive signal Com is supplied from the drive signal generation circuit 12d to the drive element via the switch circuit 3d of the head unit 3. Here, among waveforms included in the drive signal Com, a signal of a waveform actually supplied to the drive element is a drive pulse PD. The switch circuit 3d switches whether to supply at least a part of the waveforms included in the drive signal Com as the drive pulse PD, based on the control signal SI.

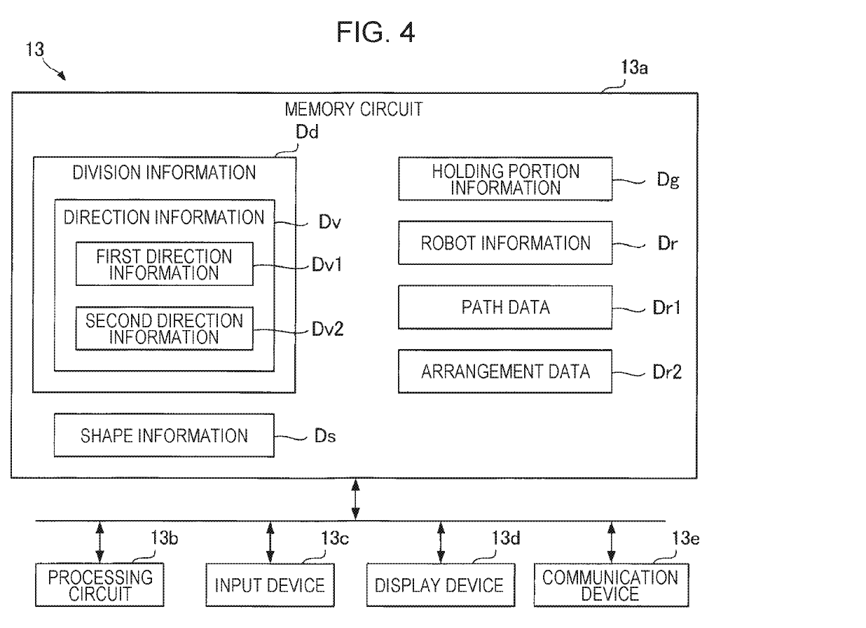

The computer 13 is a desktop type, a laptop type, a tablet type, or another type of computer that is communicably connected to the controller 11 and the control module 12. The computer 13 has a function of generating the print data Img, the path data Dr1, and the arrangement data Dr2, a function of supplying information such as the path data Dr1 and the arrangement data Dr2 to the controller 11, and a function of supplying information such as the print data Img to the control module 12. Details of the computer 13 will be described later with reference to FIG. 4.

The print data Img is information indicating an image to be printed on the workpiece W for each path of a printing trajectory indicated by path data Dr1a.

### 1-3. Configuration Example of Robot

FIG. 3 is a perspective view of the robot 2. Hereinafter, a configuration example of the robot 2 will be described. Since the configuration of the holding robot 4 is the same as that of the robot 2 except that the mounted end effector is different, the description thereof will be omitted. However, as described above, the configurations of the robot 2 and the holding robot 4 may be different from each other.

In the example shown in FIG. 3, the arm 220 of the robot 2 is a six-axis robot arm having a base end attached to the base portion 210 and a tip end whose position and orientation are three-dimensionally changed with respect to the base end. Specifically, the arm 220 includes arms 221, 222, 223, 224, 225, and 226, which are also referred to as links, and these are coupled in this order.

The arm 220 has joints J1 to J6. The joints J1 to J6 rotate about rotation axes O1 to O6, respectively. The joints J1 to J6 are provided in this order from the base portion 210 toward the arm 226 of the arm 220.

Each of the joints J1 to J6 is a mechanism that rotatably couples one of two adjacent members of the base portion 210 and the arms 221 to 226 to the other. Although not shown in FIG. 3, each of the joints J1 to J6 is provided with a drive mechanism for rotating one of the two adjacent members with respect to the other. The drive mechanism includes, for example, a motor that generates a driving force for the rotation, a speed reducer that decelerates and outputs the driving force, and an encoder such as a rotary encoder that detects an operation amount such as an angle of the rotation. An assembly of the drive mechanisms of the joints J1 to J6 corresponds to the above-described arm drive mechanism 2a shown in FIG. 2.

The rotation axis O1 is an axis perpendicular to the installation surface FB to which the base portion 210 is fixed. The rotation axis O2 is an axis perpendicular to the rotation axis O1. The rotation axis O3 is an axis parallel to the rotation axis O2. The rotation axis O4 is an axis perpendicular to the rotation axis O3. The rotation axis O5 is an axis perpendicular to the rotation axis O4. The rotation axis O6 is an axis perpendicular to the rotation axis O5.

With respect to these rotation axes, the term "perpendicular" includes not only the case where the angle formed by the two rotation axes is exactly 90°, but also the case where the angle formed by the two rotation axes intersects within a range of about ±5° from 90°. Similarly, the term "parallel" includes not only the case where the two rotation axes are strictly parallel to each other but also the case where one of the two rotation axes is inclined with respect to the other within a range of about ±5°.

The head unit 3 is mounted as an end effector on the arm 226 of the arm 220 described above. The head unit 3 is mounted on the arm 226 such that, for example, a normal to the nozzle surface FN is parallel to the rotation axis O6, that is, the ejection direction of the ink from the nozzle N is parallel to the rotation axis O6. The normal to the nozzle surface FN or the ejection direction of the ink from the nozzle N may be inclined with respect to the rotation axis O6.

Here, a tool coordinate system is set in the head unit 3. The coordinate axes of the tool coordinate system change the relative position and orientation relationship with the above-described X-axis, Y-axis, and Z-axis by the above-described operation of the robot 2. However, the tool coordinate system and the above-described base coordinate system are associated with each other by calibration. In addition, the tool coordinate system is set such that, for example, the center of the nozzle surface FN becomes a reference (tool center point).

As described above, the head unit 3 includes the liquid ejection head 3a and the curing light source 3c, and these are supported by the arm 226 in a state in which a relative positional relationship is fixed via a support body (not shown).

Although not shown, the liquid ejection head 3a includes a piezoelectric element which is a drive element and a cavity for accommodating inks, for each nozzle N. Here, the piezoelectric element ejects the ink from a nozzle corresponding to the cavity by changing a pressure of the cavity corresponding to the piezoelectric element.

The curing light source 3c emits energy such as light, heat, an electron beam, or radiation for curing or solidifying the ink on the workpiece W. The curing light source 3c is formed of, for example, a light emitting element such as a light emitting diode (LED) that emits ultraviolet rays. The curing light source 3c may be provided or omitted as necessary.

In addition to the liquid ejection head 3a and the curing light source 3c, the head unit 3 may include, for example, a pressure regulating valve that regulates the pressure of the ink in the liquid ejection head 3a.

### 1-4. Computer

FIG. 4 is a block diagram of the computer 13 used for generating the path data Dr1. As shown in FIG. 4, the computer 13 includes a display device 13d, an input device 13c, a memory circuit 13a, a processing circuit 13b, and a communication device 13e. These are communicatively connected to each other.

The display device 13d displays various images under the control of the processing circuit 13b. Here, the display device 13d includes, for example, various display panels such as a liquid crystal display panel or an organic electro-luminescence (EL) display panel. Here, on the display device 13d, information necessary for generation of the path data Dr1 is displayed as appropriate under the control of the processing circuit 13b, as necessary. The display device 13d may be provided outside the computer 13.

The input device 13c is a device that receives an operation from a user. For example, the input devices 13c include pointing devices such as a touch pad, a touch panel, and a mouse. When the input device 13c includes a touch panel, the input device 13c may also serve as the display device 13d. Further, the input device 13c may be provided outside the computer 13. The input device 13c may be provided or omitted as necessary.

The communication device 13e is a device that communicates with another device in a wireless or wired manner under the control of the processing circuit 13b. For example, the communication device 13e includes an interface such as a universal serial bus (USB) or a local area network (LAN).

The memory circuit 13a is a device that stores various programs to be executed by the processing circuit 13b and various types of data to be processed by the processing circuit 13b. The memory circuit 13a includes, for example, a hard disk drive or a semiconductor memory. A part or all of the memory circuit 13a may be provided in a storage device, a server, or the like outside the computer 13.

The memory circuit 13a stores shape information Ds, division information Dd, holding portion information Dg, robot information Dr, the path data Dr1, and the arrangement data Dr2. In addition, head information regarding the head unit 3 such as the liquid ejection head 3a or the curing light source 3c may be recorded in the memory circuit 13a.

The shape information Ds is information indicating a shape of the workpiece W. The shape information Ds is, for example, three-dimensional data in a standard triangulated language (STL) format or the like representing the shape of the workpiece W by a plurality of polygons, and includes coordinate information which is information regarding coordinates of each vertex of the polygon, and vector information which is information regarding a normal vector indicating the front and back of the polygon surface. The shape information Ds is obtained, for example, by performing conversion processing as necessary on computer-aided design (CAD) data indicating a three-dimensional shape of the workpiece W, or by measuring the shape of the workpiece W using a three-dimensional measuring instrument such as a 3D camera.

The division information Dd is information indicating at least one direction. The division information Dd includes direction information Dv.

The direction information Dv is information on a specific direction toward the target region WF. The specific direction indicated by the direction information Dv is, for example, a line-of-sight vector Vs described later, an angle designated by a user, or the like. More specifically, the direction information Dv is information regarding a plurality of directions toward the target region WF, and includes first direction information Dv1 and second direction information Dv2. The first direction information Dv1 is information on a first direction toward the target region WF. The second direction information Dv2 is information on a second direction different from the first direction toward the target region WF. The number of directions indicated by the direction information Dv may be two or more, can be freely set according to the shape of the workpiece W, designation by the user, or the like, and is not particularly limited.

The holding portion information Dg is information on the workpiece holding portion HJ. The holding portion information Dg includes, for example, information regarding a relationship between the orientations of the arms of the robot 2 that supports the liquid ejection head 3a and the holding robot 4 that supports the workpiece holding portion HJ, the posture and position of the workpiece W, the positional relationship between the workpiece W and the holding robot 4 that supports the workpiece holding portion HJ, and the like.

The robot information Dr is information regarding the robot 2. The robot information Dr includes, for example, information indicating a type, an operation error, a movable range, or the like of the robot 2.

The processing circuit 13b is a device having a function of controlling each unit or the like of the computer 13 and a function of processing various kinds of data. The processing circuit 13b includes, for example, a processor such as a CPU. The processing circuit 13b may be constituted by a single processor or may be constituted by a plurality of processors. A part or all of the functions of the processing circuit 13b may be realized by hardware such as a DSP, an ASIC, a PLD, or an FPGA.

The processing circuit 13b realizes various functions by reading the program from the memory circuit 13a and executing the program. Specifically, the processing circuit 13b realizes the function of generating the print data Img, the path data Dr1, and the arrangement data Dr2, the function of supplying information such as the path data Dr1 and the arrangement data Dr2 to the controller 11, and the function of supplying information such as the print data Img to the control module 12.

### 1-5. Printing Operation

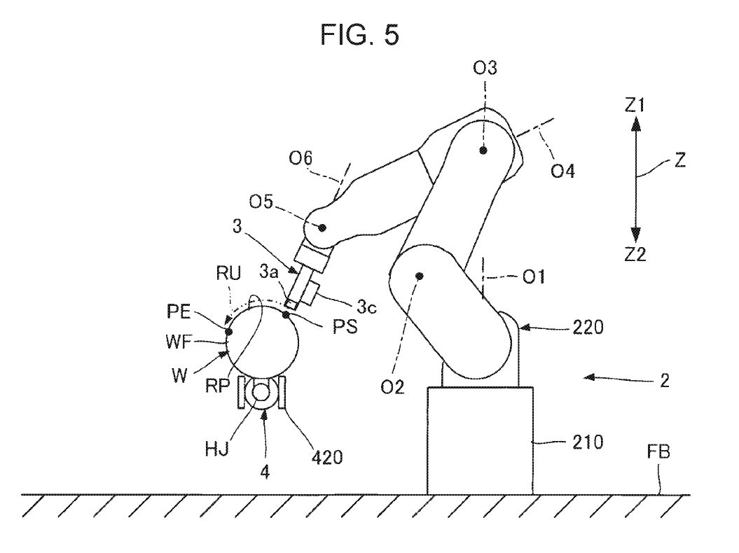

FIG. 5 is an explanatory diagram of printing with respect to the workpiece W. When printing is performed with respect to the workpiece W, as shown in FIG. 5, in a state in which the holding robot 4 supports the workpiece W at the position and orientation indicated by the arrangement data Dr2, the liquid ejection head 3a ejects ink toward the target region RP on the workpiece W at the timing indicated by the print data Img while the robot 2 moves the liquid ejection head 3a at the position and orientation indicated by the path data Dr1.

Here, the robot 2 moves the liquid ejection head 3a along the printing trajectory RU based on the path data Dr1. The printing trajectory RU is a trajectory for scanning the liquid ejection head 3a along the target region RP on the workpiece W. Further, the holding robot 4 arranges the workpiece W based on the arrangement data Dr2 before the operation based on the path data Dr1 of the robot 2.

In the present embodiment, in the printing operation, the holding robot 4 does not operate, and the robot 2 operates. Therefore, vibration of the workpiece W can be prevented. Here, from the viewpoint of reducing meandering of the printing trajectory RU of the liquid ejection head 3a, it is preferable that the number of joints operated by the robot 2 in the printing operation is as small as possible. Therefore, in FIG. 5, an aspect in which the liquid ejection head 3a is moved by operations of joints J2, J3, and J5 of three rotation axes O2, O3, and O5 parallel to each other is exemplified. In this aspect, from the viewpoint of reducing meandering of the printing trajectory RU of the liquid ejection head 3a, it is preferable that the joints other than the joints J2, J3, and J5 are not operated. Accordingly, the printing trajectory RU has a linear shape when viewed in the direction along the Z-axis. In the printing operation, the rotation axis O5 may be non-parallel to the rotation axes O2 and O3, and joints other than the joints J2, J3, and J5 may operate. In addition, the printing trajectory RU may be curved or bent when viewed in the direction along the Z-axis.

In the example shown in FIG. 5, in the printing operation, the robot 2 changes the arm 220 from a retracted state to an extended state. Thereby, it is possible to reduce the vibration of the liquid ejection head 3a due to the operation of the robot 2, compared to the aspect in which the arm 220 is changed from the extended state to the retracted state. In the printing operation, the robot 2 may change the arm 220 from the extended state to the retracted state.

The printing trajectory RU is set for each of a plurality of regions obtained by dividing the target region RP. In the related art, the target region WF is divided in accordance with the shape of the workpiece W regardless of the positional relationship between the workpiece W and the liquid ejection head 3a during printing. In such an aspect of the related art, it is difficult to generate an appropriate printing trajectory RU for workpieces W having various shapes.

Therefore, the three-dimensional object printing apparatus 1 divides the target region RP into a plurality of division regions RD to be described later based on the division information Dd, and then generates the printing trajectory RU for each division region RD. Hereinafter, a method of generating the printing trajectory RU will be described.

### 1-6. Printing Trajectory Generation Method

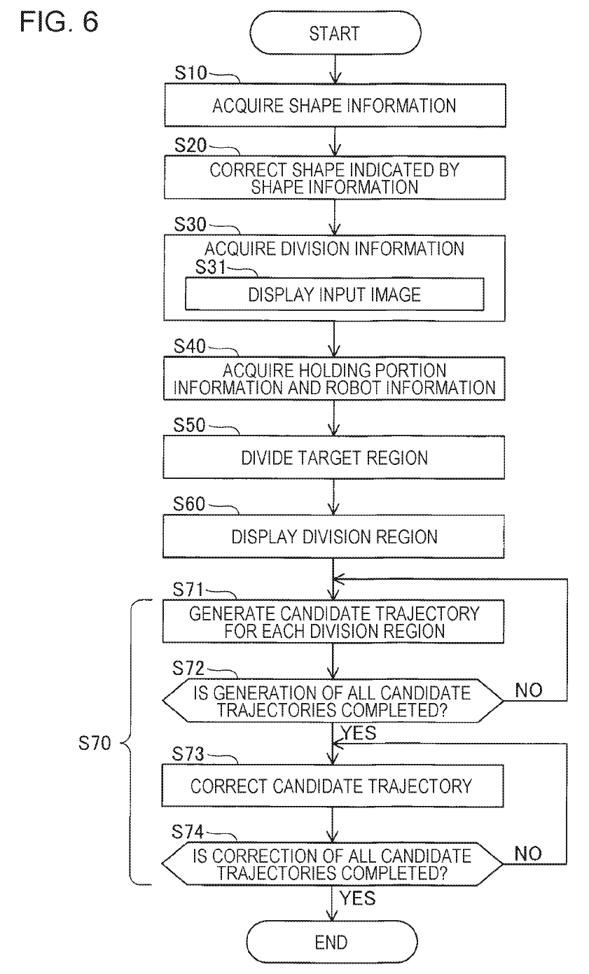

FIG. 6 is a flowchart showing the trajectory generation method according to the embodiment. The trajectory generation method is a method of generating the printing trajectory RU, and includes steps S10 to S70 executed by the control unit 10. Step S10 is an example of a "shape acquisition step". Step S20 is an example of a "shape correction step". Step S30 is an example of a "division information acquisition step". Step S50 is an example of a "division step". Step S70 is an example of a "trajectory generation step".

In Step S10, the processing circuit 13b acquires the shape information Ds. More specifically, in Step S10, the processing circuit 13b acquires the shape information Ds, for example, by reading the shape information Ds from the memory circuit 13a or by causing a three-dimensional measuring instrument (not shown) to measure the shape of the workpiece W.

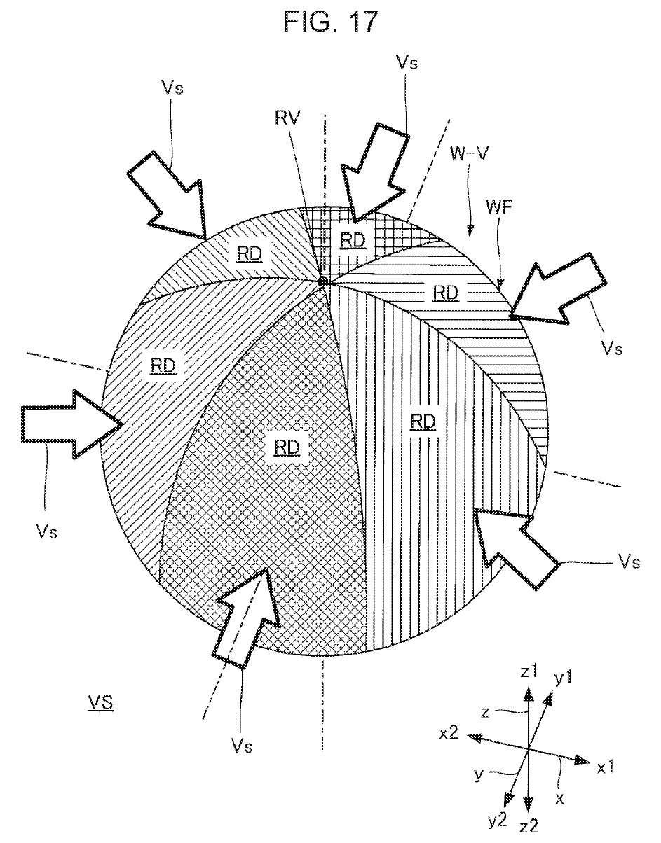

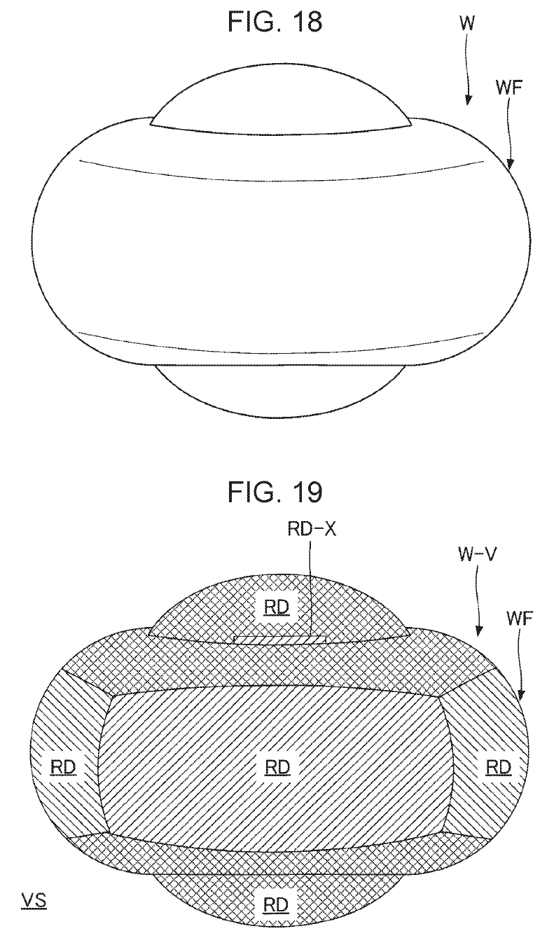

After Step S10, in Step S20, the processing circuit 13b performs correction for smoothing the shape indicated by the shape information Ds. For example, the processing circuit 13b smoothes the shape so as to even out unevenness in the shape indicated by the shape information Ds. As described above, Step S20 is performed before Step S40 which is a division step. The details of Step S20 will be described later with reference to FIGS. 18 to 21. In addition, Step S20 may be performed or omitted as necessary.

After Step S20, in Step S30, the processing circuit 13b acquires the division information Dd. In the present embodiment, Step S30 includes Step S31. In Step S31, the processing circuit 13b causes the display device 13d to display an input image GU to be described later. As will be described in detail later, the input image GU is an image for inputting the division information Dd by the user, and displays the workpiece W in the virtual space as a virtual workpiece W-V to be described later, in addition to a field GR to be described later for the input. As described above, Step S31 is a step of displaying the virtual workpiece W-V and the field GR to be described later.

After Step S30, in Step S40, the processing circuit 13b acquires the holding portion information Dg and the robot information Dr. More specifically, in Step S40, the processing circuit 13b acquires the holding portion information Dg and the robot information Dr, for example, by reading the holding portion information Dg and the robot information Dr from the memory circuit 13a. As described above, Step S40 is a step of acquiring the holding portion information Dg and the robot information Dr.

The step of acquiring the holding portion information Dg and the step of acquiring the robot information Dr may be separate steps. In addition, the step of acquiring the holding portion information Dg may be executed before Step S50, and is not limited to the shown example. However, when the holding portion information Dg is not used in Step S50 but is used only in Step S70, the step of acquiring the holding portion information Dg may be executed before Step S70. The step of acquiring the robot information Dr may be executed before Step S70, and is not limited to the shown example. In addition, Step S40 may be performed or omitted as necessary.

After Step S40, in Step S50, the processing circuit 13b divides the target region WF on the workpiece W in accordance with the division information Dd to generate a plurality of division regions RD to be described later. In the present embodiment, in Step S50, the processing circuit 13b divides the target region WF on the workpiece W using the holding portion information Dg in addition to the division information Dd.

By dividing the target region WF according to the holding portion information Dg, the division regions RD can be set in consideration of the holding portion information Dg. As a result, it is possible to suppress occurrence of a region in which the liquid ejection head 3a cannot face the division region RD, and to perform printing with the workpiece W being in a more suitable orientation. In contrast, in a mode in which the holding portion information Dg is not considered, depending on the position of the workpiece holding portion HJ or the orientation of the workpiece W, a specific division region RD may not be capable of facing the liquid ejection head 3a.

For example, when an angle formed by the orientation of the arm of the robot supporting the liquid ejection head 3a and the orientation of the arm 420 of the holding robot 4 supporting the workpiece holding portion HJ is 90° and the surface of the workpiece W is spherical, there is a problem in that it is difficult for the robot 2 and the holding robot 4 to mutually take the postures when printing the top surface of the workpiece W, and the degree of difficulty of printing changes depending on the orientations of the robot 2 and the holding robot 4.

After Step S50, in Step S60, the processing circuit 13b causes the display device 13d to display a plurality of division regions RD to be described later. As described above, Step S60 is a step of displaying the plurality of division regions RD. This display mode is similar to a display mode of the virtual workpiece W-V in Step S30, for example.

After Step S60, in Step S70, the processing circuit 13b generates a printing trajectory RU of the liquid ejection head 3a with respect to the plurality of division regions RD, which will be described later, for each division region RD. More specifically, Step S70 includes Step S71 to Step S74.

In Step S71, the processing circuit 13b generates a plurality of trajectory candidates RUC, which will be described later, for each division region RD described later. After Step S71, in Step S72, the processing circuit 13b determines whether or not a plurality of trajectory candidates RUC have been generated for all of the division regions RD, and repeats Step S71 until the plurality of trajectory candidates RUC are generated for all of the division regions RD (Step S72: NO).

When the plurality of trajectory candidates RUC is generated for all the division regions RD (Step S72: YES), in Step S73, the processing circuit 13b generates the printing trajectory RU by correcting the plurality of trajectory candidates RUC to be described later for each division region RD described later. After Step S73, in Step S74, the processing circuit 13b determines whether or not the plurality of trajectory candidates RUC have been corrected for all of the division regions RD, and repeats Step S73 until the plurality of trajectory candidates RUC are corrected for all of the division regions RD (Step S74: NO).

When the plurality of trajectory candidates RUC is corrected for all of the division regions RD (Step S74: YES), the processing circuit 13b ends the process. As described above, the printing trajectory RU is generated for all the division regions RD.

In the present embodiment, in Step S70, the processing circuit 13b generates the printing trajectory RU according to the robot information Dr. More specifically, the processing circuit 13b generates the trajectory candidate RUC according to the robot information Dr in Step S71, or corrects the trajectory candidate RUC according to the robot information Dr in Step S73. Accordingly, it is possible to generate the printing trajectory RU in consideration of the operation error, the movable range, or the like of the robot 2 according to the robot information Dr. Therefore, it is possible to operate the robot 2 with high accuracy at the time of printing, and as a result, it is possible to improve printing quality. The printing trajectory RU may be generated without using the robot information Dr.

In addition, in Step S70, the processing circuit 13b generates the printing trajectory RU for each division region RD according to the shape information Ds and the holding portion information Dg. In this way, it is possible to generate the optimal printing trajectory RU in consideration of the shape of the workpiece W or the configuration of the apparatus according to the holding portion information Dg for each division region RD. As a result, it is possible to improve the printing quality. The printing trajectory RU may be generated without using the holding portion information Dg. The printing trajectory RU may be generated without using one or both of the shape information Ds and the holding portion information Dg.

With the above-described trajectory generation method, the target region WF on the workpiece W can be divided based on any direction indicated by the division information Dd. Therefore, it is possible to easily generate the printing trajectory RU according to the desire of the user.

The generation of the printing trajectory RU as described above may be performed by a device such as a server connected to the three-dimensional object printing apparatus 1 via a network such as the Internet. In this case, the device is a constituent element of the three-dimensional object printing system, and corresponds to a "trajectory generation unit".

### 1-7. Acquisition of Division Information

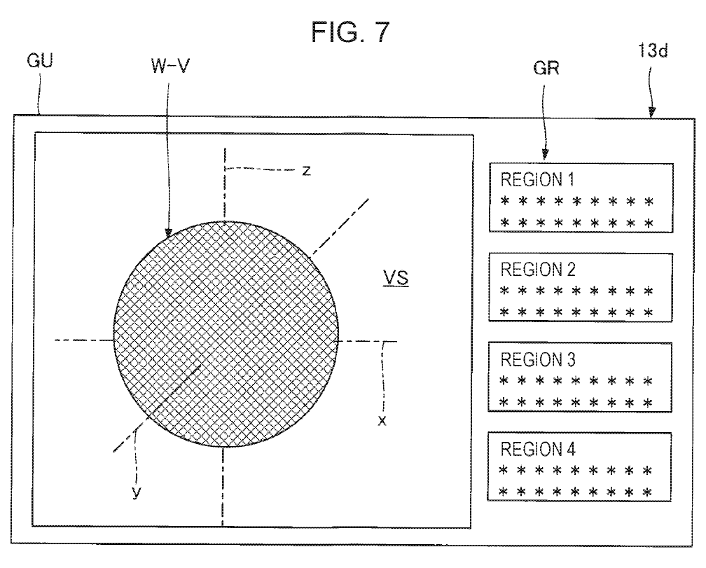

FIG. 7 is a diagram of a display example used to acquire the division information Dd. FIG. 7 shows an example of the input image GU displayed on the display device 13d in Step S31.

The input image GU is a graphical user interface (GUI) image for the user to input the division information Dd. In the example shown in FIG. 7, the input image GU includes the virtual workpiece W-V and the field GR which is an example of an "input receiving unit".

The virtual workpiece W-V is a workpiece W in the virtual space VS. In the virtual space VS, a coordinate system is set with mutually intersecting x-axis, y-axis, and z-axis as coordinate axes. Here, the x-axis, the y-axis, and the z-axis correspond to the coordinate axes of the workpiece coordinate system, and are appropriately associated with the world coordinate system or the robot coordinate system by calibration or the like. Specifically, the x-axis corresponds to the X-axis, one direction along the x-axis is an x1 direction, and a direction opposite to the x1 direction is an x2 direction. The y-axis corresponds to the Y-axis, and directions opposite to each other along the y-axis are a y1 direction and a y2 direction. The z-axis corresponds to the Z-axis, and directions opposite to each other along the z-axis are a z1 direction and a z2 direction. Although the x-axis, the y-axis, and the z-axis are typically orthogonal to each other, the configuration is not limited thereto, and all of these may intersect with each other at an angle within a range equal to or more than 80° and equal to or less than 100°.

The field GR is a component for receiving input of the division information Dd from the user, and can receive input from the user using the input device 13c. The field GR receives, for example, designation of the number and directions of line-of-sight vectors Vs to be described later. The number and shape of division regions RD to be described later change according to the number and the direction.

In this way, in Step S30 which is the division information acquisition step, the division information Dd is acquired based on the input from the user. Accordingly, in Step S50, it is possible to generate the division region RD according to the desire of the user.

### 1-8. Division of Target Region

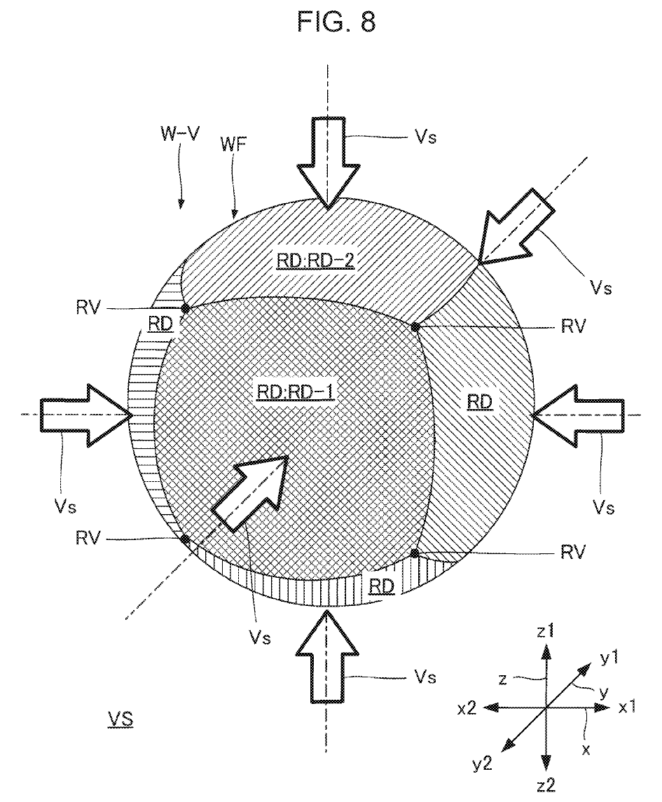

FIG. 8 is an explanatory diagram of the plurality of division regions RD. In Step S50, as shown in FIG. 8, the plurality of division regions RD are generated by dividing the target region WF in accordance with a plurality of line-of-sight vectors Vs corresponding to a plurality of directions indicated by the direction information Dv. In FIG. 8, for convenience of description, the plurality of division regions RD are displayed with different shading, hatching, or the like.

In the example shown in FIG. 8, the target region WF is divided into six in accordance with the six line-of-sight vector Vs, whereby six division regions RD are generated. Six line-of-sight vectors Vs include a line-of-sight vector Vs in the x1 direction, a line-of-sight vector Vs in the x2 direction, a line-of-sight vector Vs in the y1 direction, a line-of-sight vector Vs in the y2 direction, a line-of-sight vector Vs in the z1 direction, and a line-of-sight vector Vs in the z2 direction. The number of divisions of the target region WF is determined in accordance with the number of directions indicated by the division information Dd, that is, the number of line-of-sight vectors Vs, and is not limited to the shown example and is optional. In addition, the direction of each line-of-sight vector Vs is determined in accordance with the direction indicated by the division information Dd, and is not limited to the shown example and is optional.

Here, each division region RD is set so as to be the front when viewed from the direction of the corresponding line-of-sight vector Vs. More specifically, for example, after calculating the inner product of each line-of-sight vector Vs and the normal vector of each polygon of the target region WF, the target region WF is divided for each line-of-sight vector Vs so that the inner product is minimized, thereby generating the division region RD corresponding to each line-of-sight vector Vs.

That is, the division region RD corresponding to each line-of-sight vector Vs is generated such that the angle formed by each line-of-sight vector Vs and the normal vector of each polygon of the target region WF is close to 180°. The method of obtaining the angle is not limited to the method using the inner product, and is optional.

In this way, in Step S50 which is the division step, the processing circuit 13b divides the target region WF according to the direction information Dv. Thus, the division region RD can be generated based on the input of the specific direction indicated by the direction information Dv. Therefore, it is possible to easily generate the printing trajectory RU based on the direction according to the desire of the user.

In addition, in Step S50 which is the division step, the processing circuit 13b divides the target region WF according to a plurality of directions indicated by the direction information Dv. Thus, the division region RD can be generated based on the plurality of directions indicated by the direction information Dv. Therefore, it is possible to generate the printing trajectory RU in accordance with the shape of the workpiece W or the required printing quality.

Further, in Step S50 which is the division step, the target region WF is divided according to the line-of-sight vector Vs, which is the specific direction indicated by the direction information Dv, and the angle formed by the line-of-sight vector Vs and the normal to the surface of the target region WF. Thus, the angle formed by the normal vector Vn of the surface of the workpiece W in the division region RD and the line-of-sight vector Vs is set within a specific range of an acute angle of 160° or more, whereby the division region RD can be made closer to a plane. Therefore, it is possible to reduce the variation in the angle in the division region RD. As a result, it is possible to reduce the amount of change in the angle of the liquid ejection head 3a or the workpiece W when printing is performed with respect to the division region RD.

When one division region RD of two division regions RD adjacent to each other is defined as a first region RD-1 and the other division region RD is defined as a second region RD-2, the inner product of the normal vector Vn of a surface of the first region RD-1 and the line-of-sight vector Vs along the specific direction is smaller than the inner product of the normal vector Vn of a surface of the second region RD-2 and the line-of-sight vector Vs along the specific direction. Accordingly, it is possible to appropriately set the division region RD which can be printed from a designated direction.

Further, each of the plurality of division regions RD does not include a collective region RV in which four or more division regions RD gather. As a result, it is possible to limit the number of division regions RD that gather at the collective region RV to three or less. The collective region RV is located at a boundary where the plurality of division regions RD are in contact with each other, and is located at four corners of the division region RD in FIG. 8. As a result, it is possible to suppress a decrease in printing quality in the collective region RV. On the other hand, when the number of division regions RD that gather at the collective region RV is four or more, a printing error is likely to occur in each division region RD in the collective region RV. In particular, when the operation directions of the liquid ejection head 3a with respect to the plurality of division regions RD that gather at the collective region RV are different from each other, a decrease in printing quality due to the printing error is significant.

The result of the division as described above is displayed on the display device 13d in Step S60, in a manner similar to the display of the virtual workpiece W-V in Step S31 described above. For example, the generated division regions RD are displayed in different colors for each division region RD on the virtual workpiece W-V. By such steps S31 and S60, it is possible to provide the simulation by the display of the plurality of division regions RD based on the input result by the user. Therefore, it is possible to easily generate the plurality of division regions RD according to the desire of the user.

### 1-9. Generation of Printing Trajectory

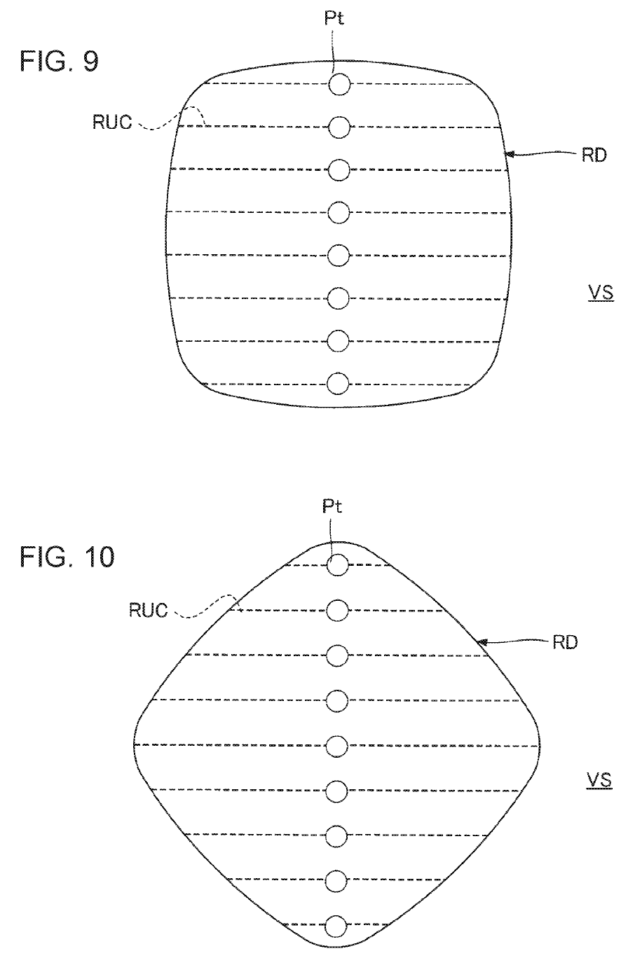

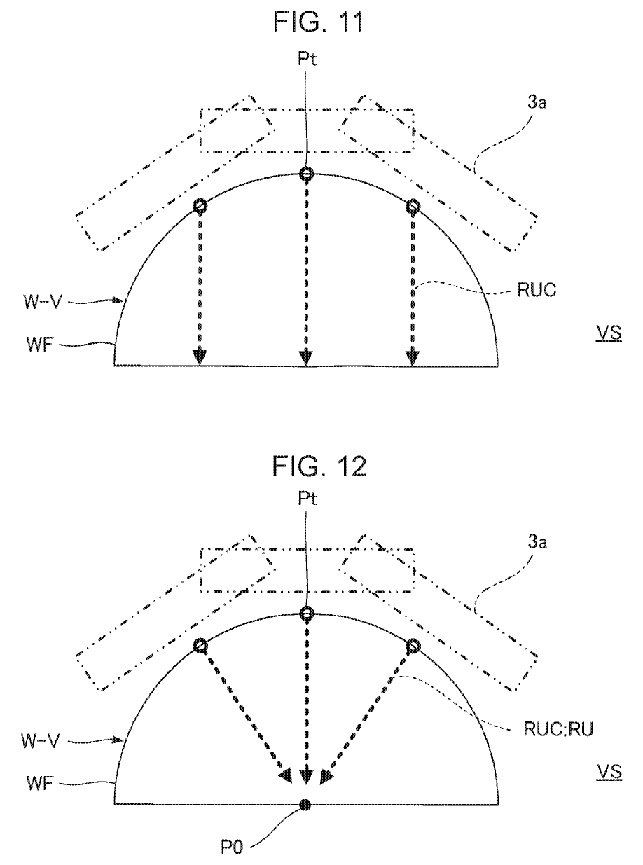

FIGS. 9 and 10 are diagrams showing examples of a plurality of trajectory candidates RUC. FIG. 11 is an explanatory diagram of the plurality of trajectory candidates RUC. FIG. 9 representatively shows an example of a plurality of trajectory candidates RUC corresponding to one division region RD. FIG. 10 representatively shows another example of a plurality of trajectory candidates RUC corresponding to one division region RD. In FIG. 11, three trajectory candidates RUC among the plurality of trajectory candidates RUC shown in FIG. 9 or 10 are three-dimensionally shown. In FIG. 11, the liquid ejection head 3a corresponding to a center point Pt to be described later is also shown.

In Step S71, as shown in FIG. 9 or 10, the processing circuit 13b corrects each division region RD onto a two-dimensional plane in the virtual space VS, and then generates a plurality of trajectory candidates RUC at regular intervals on the two-dimensional plane. Here, the division region RD corrected onto the two-dimensional plane corresponds to the division region RD viewed from the direction of the corresponding line-of-sight vector Vc. That is, in Step S71, the processing circuit 13b generates a plurality of trajectory candidates RUC at regular intervals in the direction of the line-of-sight vector Vc with respect to the division region RD in the virtual space VS. The plurality of trajectory candidates RUC shown in FIG. 10 are the same as the plurality of trajectory candidates RUC shown in FIG. 9 except that the directions are different.

Further, in Step S71, the processing circuit 13b sets the center point Pt of each trajectory candidate RUC. The center point Pt corresponds to the midpoint of the trajectory candidate RUC.

As shown in FIG. 11, the plurality of trajectory candidates RUC as described above have a shape corresponding to a shape obtained by slicing the workpiece W.

FIG. 12 is an explanatory diagram of correction of the plurality of trajectory candidates RUC. In FIG. 12, the printing trajectory RU resulting from the correction of the three trajectory candidates RUC corresponding to FIG. 11 is shown.

In Step S73, the processing circuit 13b generates the printing trajectory RU by correcting the plurality of trajectory candidates RUC so that, for each trajectory candidate RUC, a virtual plane including the trajectory candidate RUC passes through the common point P0. The correction process in Step S73 may be executed or omitted as necessary. For example, when the division region RD is relatively flat, the printing trajectory RU may be generated without correcting the plurality of trajectory candidates RUC.

As described above, by executing Step S73 after Step S71, it is possible to generate the printing trajectory RU having a shape corresponding to a comb-cut shape of the workpiece W. Therefore, it is possible to generate the printing trajectory RU capable of maintaining the nozzle surface parallel to the surface of the workpiece W while reducing the orientation change of the liquid ejection head 3a. As a result, the printing quality can be improved.

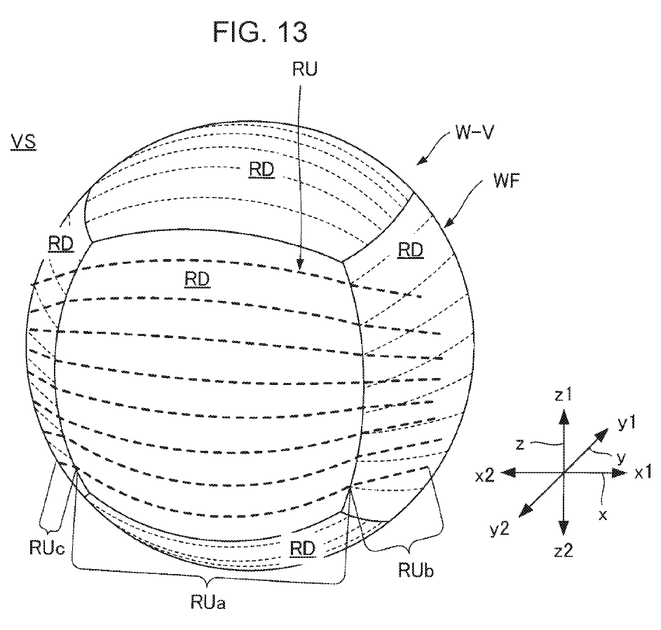

FIG. 13 is an explanatory diagram of a plurality of printing trajectories RU. FIG. 13 shows a plurality of printing trajectories RU when using the plurality of trajectory candidates RUC shown in FIG. 9. In addition, in FIG. 13, for convenience of viewing, a plurality of printing trajectories RU corresponding to one division region RD among the plurality of division regions RD are representatively shown, and only a trajectory RUa to be described later among the plurality of printing trajectories RU of the other division regions RD is shown by broken lines.

In Step S73, after the trajectory candidate RUC is corrected as described above, as shown in FIG. 13, a trajectory RUb and a trajectory RUc are added to the trajectory RUa based on the trajectory candidate RUC, thereby generating the printing trajectory RU constituted by the trajectory RUa, the trajectory RUb, and the trajectory RUc. The trajectory RUb is a lead-in trajectory for stabilizing the moving speed and the orientation of the liquid ejection head 3a. The trajectory RUc is a trajectory for stabilizing the moving speed and the orientation of the liquid ejection head 3a in the vicinity of the end point of the trajectory RUa and curing or solidifying the ink ejected in the vicinity of a terminal end of the trajectory RUa.

The trajectory RUa is a trajectory corresponding to the above-described corrected trajectory candidate RUC and crosses the corresponding division region RD. The trajectory RUb is a trajectory coupled to the start point of the trajectory RUa, and overlaps the division region RD adjacent to the corresponding division region RD. The trajectory RUc is a trajectory coupled to the end point of the trajectory RUa, and overlaps the division region RD adjacent to the corresponding division region RD. The direction, the length, and the like of the trajectory RUb and the trajectory RUc are set by, for example, designation of the user.

The trajectory RUa may be divided into a plurality of trajectories. For example, the processing circuit 13b divides the trajectory RUa into a plurality of trajectories along the trajectory RUa according to the movable range of the robot 2 or the orientation of the liquid ejection head 3a. At this time, the processing circuit 13b may set trajectories corresponding to the trajectories RUb and RUc for each of the divided trajectories.

### 1-10. Other examples of Printing Trajectories

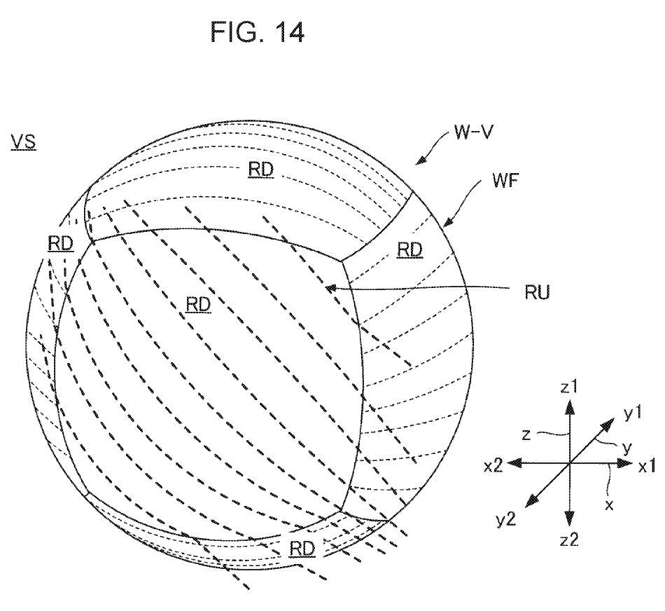

FIGS. 14 to 16 are explanatory diagrams of other examples of the plurality of printing trajectories RU. FIG. 14 shows a plurality of printing trajectories RU when using the plurality of trajectory candidates RUC shown in FIG. 10 for only one division region RD of the plurality of division regions RD.

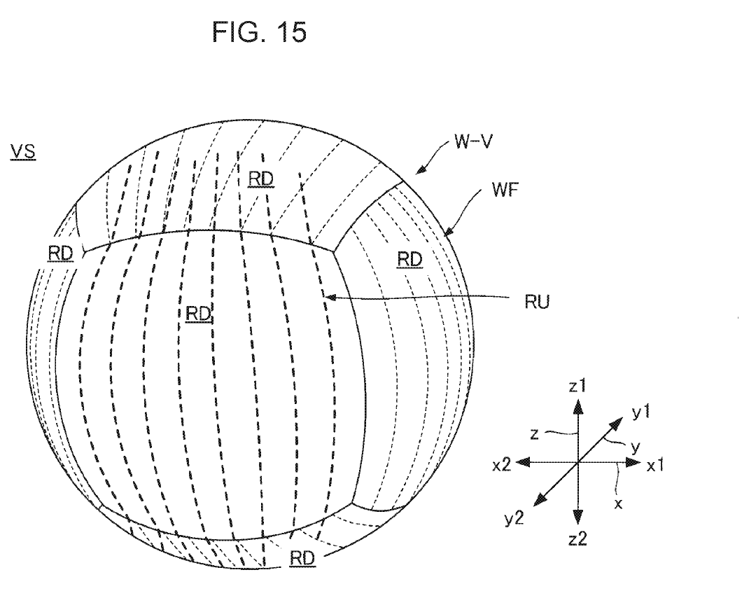

In the example shown in FIG. 13 described above, each of the plurality of printing trajectories RU is set to extend in a direction orthogonal to the z-axis as much as possible. On the other hand, in the example shown in FIG. 15, each of the plurality of printing trajectories RU is set to extend in a direction parallel to the z-axis as much as possible. It may be possible to select whether to set the plurality of printing trajectories RU as shown in FIG. 13 or to set the plurality of printing trajectories RU as shown in FIG. 15. For example, the selection may be performed by an instruction of the user, or may be performed based on one or both of the holding portion information Dg and the robot information Dr.

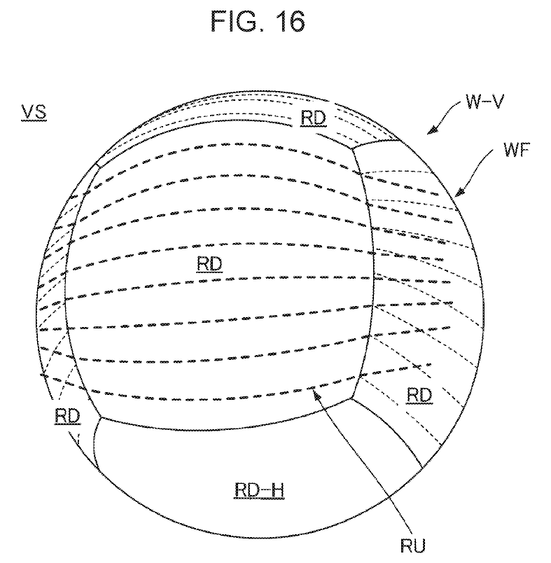

In the example shown in FIG. 16, the printing trajectory RU is not generated for a division region RD-H which is one division region RD among the plurality of division regions RD. The division region RD-H is, for example, a portion held by the workpiece holding portion HJ. The division region RD-H is specified based on, for example, the holding portion information Dg.

### 1-11. Another Example of Division Region

FIG. 17 is an explanatory diagram of another example of the plurality of division regions RD. In the example shown in FIG. 17, each of six line-of-sight vectors Vs is set to be orthogonal to the z-axis, and the six line-of-sight vectors Vs are set to face different directions so as to be at equal angular intervals. The number of divisions of the target region WF is determined in accordance with the number of directions indicated by the division information Dd, that is, the number of line-of-sight vectors Vs, and is not limited to the shown example and is optional. In addition, directions of the respective line-of-sight vectors Vs are determined in accordance with directions indicated by the division information Dd, and are not limited to the shown example. For example, the directions may not be at equal angular intervals.

Each of the plurality of division regions RD has a collective region RV in which six division regions RD gather.

### 1-12. Other Examples of Workpiece Shape

FIG. 18 is a diagram showing an example of a workpiece W having a recessed portion. FIG. 19 is an explanatory diagram of a case where a plurality of division regions RD are generated without smoothing the shape of the workpiece W shown in FIG. 18. When the plurality of division regions RD are generated without smoothing a shape of the workpiece W having the shape as shown in FIG. 18, as shown in FIG. 19, a part RD-X of one of the division regions RD is formed in a recessed portion of the workpiece W at a position separated from and inside another division region RD.

That is, in a mode in which the surface of the workpiece W is not smoothed, the part RD-X which is a scattered area is generated in the division region RD depending on the degree of unevenness of the surface of the workpiece W. In this case, it is difficult to appropriately set the movable amount, the displacement amount, the alignment, and the like of the liquid ejection head 3a.

As described above, in a mode in which the surface of the workpiece W is not smoothed, when the surface of the workpiece W has unevenness, variations in normal vectors caused by the unevenness during division of the target region WF make the division regions RD complicated, and therefore it is not possible to appropriately generate the division regions RD.

Therefore, in the three-dimensional object printing apparatus 1, as necessary, in Step S20, the processing circuit 13b performs correction for smoothing the shape indicated by the shape information Ds.

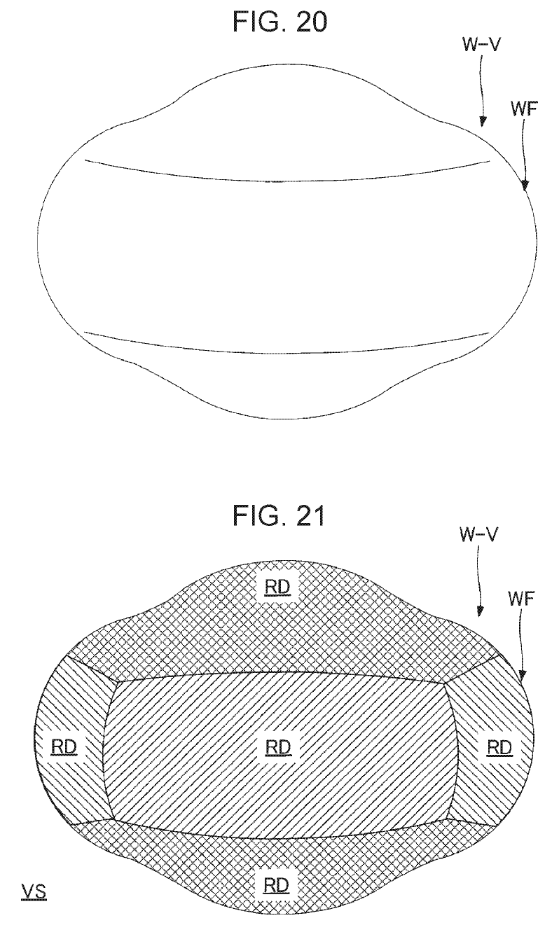

FIG. 20 is an explanatory diagram of a state after the shape of the workpiece W shown in FIG. 18 is smoothed. FIG. 21 is an explanatory diagram of a case where a plurality of division regions RD are generated after the shape of the workpiece W shown in FIG. 18 is smoothed. In Step S20, the shape of the virtual workpiece W-V is smoothed as shown in FIG. 20. After such smoothing, by generating the plurality of division regions RD in Step S50, the plurality of division regions RD can be generated without generating a portion such as the part RD-X described above.

In this way, even when the surface of the workpiece W has unevenness, the target region WF is divided after the surface of the workpiece W is smoothed by performing correction for smoothing the shape indicated by the shape information Ds. Therefore, it is possible to suppress variation in the normal vector Vn in the target region WF at the time of division, and as a result, it is possible to suppress complication of the division region RD.

A specific smoothing method is not particularly limited, and examples thereof include a method using convex hull processing, a method using alpha shape processing, and a method using alpha wrapping processing. Among these processing, the convex hull processing is preferable.

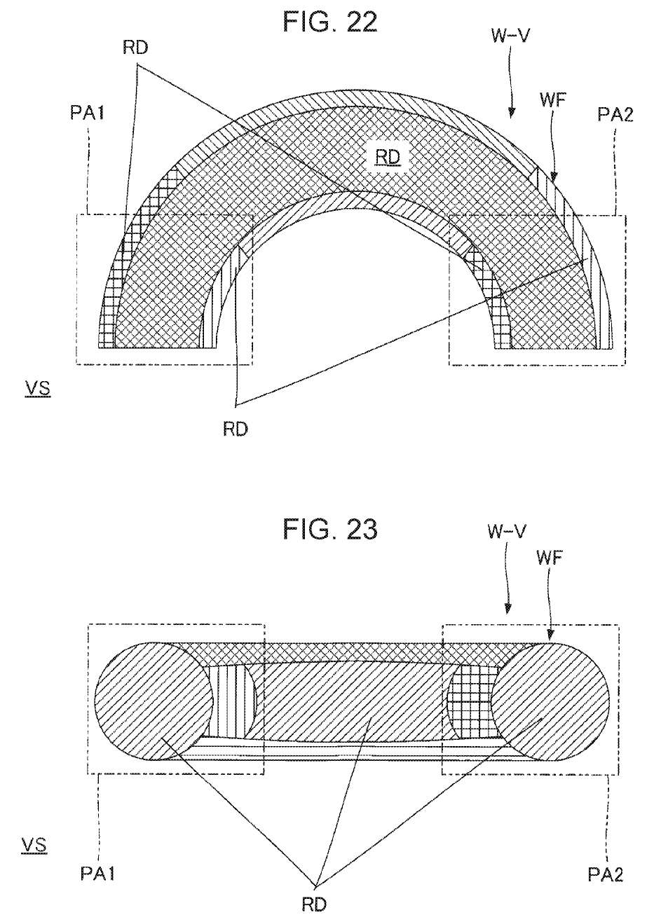

FIG. 22 is an explanatory diagram of a plurality of division regions RD in a case where the workpiece W has two separated portions PA1 and PA2. FIG. 23 is a view of the plurality of division regions RD shown in FIG. 22 as viewed from another direction. In the example shown in FIG. 22, the workpiece W has an elongated shape curved in a U-shape, and the portions PA1 and PA2 separated from each other are provided at both end portions of the workpiece W.

In such a case, as shown in FIGS. 22 and 23, at least one division region RD of the plurality of division regions RD may be constituted by a plurality of regions separated from each other.

### 2. Modification Example

The embodiments exemplified above can be modified in various ways. Specific modification aspects that can be applied to each of the embodiments described above are exemplified below. Two or more aspects appropriately selected from the following examples can be appropriately combined within a range in which the two or more aspects do not contradict each other.

### 2-1. Modification Example 1

In the above-described embodiment, a configuration in which a six-axis vertical multi-axis robot is used as a moving mechanism is exemplified, but the present disclosure is not limited to the configuration. The moving mechanism may be capable of three-dimensionally changing the relative position and the orientation of a liquid ejection head with respect to the workpiece. Therefore, the moving mechanism may be, for example, a vertical multi-axis robot other than a six-axis robot or may be a horizontal multi-axis robot. In addition, the robot arm may have an expansion/retraction mechanism or the like in addition to the joint constituted by the rotation mechanism. Further, the moving mechanism may be a robot having a parallel link mechanism. However, from the viewpoint of the balance between the printing quality in the printing operation and the degree of freedom of the operation of the moving mechanism in the non-printing operation, the moving mechanism is preferably a multi-axis robot having six or more axes. Further, a dual-arm robot may be used, and in this case, one arm can be used as a first robot, and the other arm can be used as a second robot.

Further, the moving mechanism may be a direct-acting mechanism that changes the position of the liquid ejection head 3a along two axes of the X-axis and the Z-axis without changing the orientation of the liquid ejection head 3a.

### 2-2. Modification Example 2

In the above-described embodiment, a configuration in which screwing or the like is used as a method of fixing the head to the robot is exemplified, but the present disclosure is not limited to the configuration. For example, the head may be fixed to the robot by gripping the head by a gripping mechanism such as a hand mounted as an end effector of the robot.

### 2-3. Modification Example 3

In the above-described embodiment, an aspect in which the computer 13 generates the printing trajectory is exemplified, but the present disclosure is not limited to this aspect, and for example, a computer such as a server connected to the computer 13 via a network such as the Internet may generate the printing trajectory.

### 2-4. Modification Example 4

In the embodiment described above, a configuration in which printing is performed by using one type of ink is described. Meanwhile, the present disclosure is not limited to this configuration and can be applied to a configuration in which printing is performed by using two or more types of ink.

### 2-5. Modification Example 5

The use of the three-dimensional object printing apparatus of the present disclosure is not limited to printing. For example, a three-dimensional object printing apparatus that ejects a solution of a coloring material is used as a manufacturing apparatus that forms a color filter of a liquid crystal display device. A three-dimensional object printing apparatus that ejects a solution of a conductive material is used as a manufacturing apparatus that forms wiring and an electrode on a wiring substrate. Further, the three-dimensional object printing apparatus can also be used as a jet dispenser that applies a liquid such as an adhesive to a workpiece.

What is claimed is:

1. A trajectory generation method for scanning a liquid ejection head in a three-dimensional object printing apparatus including the liquid ejection head configured to eject a liquid toward a three-dimensional workpiece, and a moving mechanism configured to hold the liquid ejection head and change a relative position of the liquid ejection head with respect to the workpiece, the trajectory generation method comprising:
a shape acquisition step of acquiring shape information on a shape of the workpiece;
a division information acquisition step of acquiring division information indicating at least one direction;
a division step of dividing a target region on the workpiece in accordance with the division information to generate a plurality of division regions; and
a trajectory generation step of generating, for each division region of the plurality of division regions, a printing trajectory of the liquid ejection head.

2. The trajectory generation method according to claim 1, wherein
the division information includes direction information on a specific direction toward the target region, and
in the division step, the target region is divided in accordance with the direction information.

3. The trajectory generation method according to claim 2, wherein
the direction information includes information on a plurality of directions toward the target region, and
in the division step, the target region is divided in accordance with the plurality of directions.

4. The trajectory generation method according to claim 2, wherein
in the division step, the target region is divided in accordance with the specific direction and an angle formed by the specific direction and a normal to a surface of the target region.

5. The trajectory generation method according to claim 3, wherein
the plurality of division regions include a first region and a second region adjacent to the first region as division regions, and
an inner product of a normal vector of a surface of the first region and a vector along the specific direction is smaller than an inner product of a normal vector of a surface of the second region and the vector along the specific direction.

6. The trajectory generation method according to claim 1, wherein
in the division information acquisition step, the division information is acquired based on input from a user.

7. The trajectory generation method according to claim 6, wherein
the division information acquisition step includes displaying a virtual workpiece and an input receiving unit for receiving the input of the division information from the user, and
the method further includes displaying the plurality of division regions after the division step.

8. The trajectory generation method according to claim 1, further comprising:
a shape correction step of performing correction for smoothing a shape indicated by the shape information before the division step.

9. The trajectory generation method according to claim 1, wherein
the trajectory generation step includes, for each division region of the plurality of division regions:
correcting the division region onto a two-dimensional plane;
generating a plurality of trajectory candidates at regular intervals on the two-dimensional plane; and
generating the printing trajectory by correcting the plurality of trajectory candidates such that virtual planes each including a respective one of the plurality of trajectory candidates pass through a single common point.

10. The trajectory generation method according to claim 1, further comprising:
acquiring holding portion information on a workpiece holding portion that holds the workpiece, wherein
in the division step, the target region is divided in accordance with the holding portion information.

11. The trajectory generation method according to claim 10, wherein
the moving mechanism is a robot that changes a position and an orientation of the liquid ejection head,
the method further includes acquiring robot information on the robot, and
in the trajectory generation step, the printing trajectory is generated in accordance with the robot information.

12. The trajectory generation method according to claim 1, further comprising:
acquiring holding portion information on a workpiece holding portion that holds the workpiece, wherein
in the trajectory generation step, the printing trajectory is generated for each division region of the plurality of division regions in accordance with the shape information and the holding portion information.

13. The trajectory generation method according to claim 1, wherein
each of the plurality of division regions does not include a collective region in which four or more division regions gather.

14. A three-dimensional object printing system comprising:
a liquid ejection head configured to eject a liquid toward a three-dimensional workpiece;
a moving mechanism configured to hold the liquid ejection head and change a relative position of the liquid ejection head with respect to the workpiece; and
a trajectory generation unit configured to generate a printing trajectory for scanning the liquid ejection head, wherein
the trajectory generation unit is configured to:
acquire shape information on a shape of the workpiece;
acquire division information indicating at least one direction;
generate a plurality of division regions by dividing a target region on the workpiece in accordance with the division information; and
generate a printing trajectory of the liquid ejection head for each division region of the plurality of division regions.

15. A three-dimensional object printing apparatus comprising:
a liquid ejection head configured to eject a liquid toward a three-dimensional workpiece;
a moving mechanism configured to hold the liquid ejection head and change a relative position of the liquid ejection head with respect to the workpiece; and
a trajectory generation unit configured to generate a printing trajectory for scanning the liquid ejection head, wherein
the trajectory generation unit is configured to:
acquire shape information on a shape of the workpiece;
acquire division information indicating at least one direction;
generate a plurality of division regions by dividing a target region on the workpiece in accordance with the division information; and
generate a printing trajectory of the liquid ejection head for each division region of the plurality of division regions.
